(19) United States
(12) Patent Application Publication
(10) Pub. No.: US 2007/0125240 A1
(43) Pub. Date: Jun. 7, 2007

(54) Pot cover caddy

(76) Inventors: Ken Kasden, Sturgeon Lake, MN (US); Brad Waldack, Bruno, MN (US)

Correspondence Address: KEN KASDEN, 91580 BRANOT ROAD, STURGEON LAKE, MN, 55783, US

(21) Appl. No.: 11/635,868

(22) Filed: Dec. 7, 2006

Related U.S. Application Data
(60) Provisional application No. 60/748,290, filed on Dec. 7, 2005.

(51) Int. Cl. A47J 37/06

(52) U.S. Cl. 99/372

(57) ABSTRACT

A kitchen cooking apparatus which allows the cook a convenient area to place his or her cooking pot or pan covers during the cooking process or when not cooking, a place to store pot or pan covers. The device consists of a bottom and top which are hinged together, along with two pivotally mounted hoops connected by linkages to each other and the top and bottom. The bottom has a divided area for storage of utensils as well as a removable drip collection tray held in place by two vertical pins. The drip tray also doubles as a cooking storage area for utensils. When not in use the top and bottom fold together for convenient storage.

### CROSS REFERANCE TO RELATED APPLICATION

This application claims priority to Provisional Patent application No. 60/748,290, filed on Dec. 7, 2005.

### BACKGROUND OF THE INVENTION

This invention relates to a pot cover caddy, an ornate useful kitchen small appliance that will receive and hold hot, messy cooking pot covers, spoons, ladles and spatula's in easy to reach convenient fashion. The caddy can be left open for continued use or stored on its side, shelf, drawer or wall.

When cooking over a stove with hot pots or pans, often covers are used to aid in the cooking process. Said covers aid in retaining moisture during the cooking process and permit food to be properly prepared.

Problematically, when the cook wishes to inspect the food or remove said cooked food from the pot or pan, he or she is required to remove the cover. A sufficient problem exists as to what to do with the hot, messy cover, which may be loaded with moisture droplets or remnants of food stuck to the underside of the cover. To date the cooks have simply laid the covers onto counters, burners, paper towels, sinks or other nearby surfaces. Such an effort results in leaving moisture and food debris at the location where the cover is laid to rest. Sometimes this effort often results in the cook burning himself or herself.

There is a need for a pot cover caddy that can be located, at the cook's discretion, near the cooks stove for temporary placement of the pot covers and utensils during cooking or if cook desires, the cooking caddy may be also used for permanent storage of cooking covers and utensils.

### SUMMARY OF THE INVENTION

The pot cover caddy includes hollow supporting depressions which can be used for supporting utensils and an incertable tray with additional utensil depressions. The caddy also includes a hinged cover for closing about the base for storage or appropriately handing on a suitable wall. First and second pot cover hoops are pivotally mounted within the base and connected by linkages which assist in raising the pot cover hoops to an upright position when the cover is opened and further assist in retaining the cover in a substantially open position during use of the pot cover caddy. Further, the linkages assist in lowering the pot cover hoops into a flat overlapping position whenever the cover is closed.

A principal object and advantage of the present invention is that it safely supports hot dripping pot and pan covers during the cooking operation without messy drippings on the stove countertops or sinks and without fear of burning the cook and can be used as storage for pot and pan covers when not cooking.

Another object and advantage of the present invention is that it easily and temporarily stores utensils utilized in cooking in a manner to avoid messy countertops, burners, stove tops or the need for other carrying devises.

Another object and advantage of the present invention is that it folds compactly and may be temporarily mounted on a wall like a picture frame to display art on its top or underside when not in use or it may be stored flat or on its side to display art on any side of which it is not resting.

### BRIEF DESCRIPTIONS OF THE DRAWINGS

FIG. 1 is a prospective view of the pot cover caddy in its open and ready for use condition.

FIG. 2 is a side elevation view of the pot cover caddy in a closed condition.

FIG. 3 is an enlarged broken away top view of the rear portion of the base and bottom. portion of the cover of the caddy for ease of understanding of the hoops and linkages.

FIG. 4 is a broken away side elevation view taken along lines 4-4 of FIG. 3.

FIG. 5 is a partially broken view taken along lines 5-5 of FIG. 2.

FIG. 6 is a side elevation view of the caddy being opened from its closed position of FIG. 2.

FIG. 7 is a side elevation view of the caddy fully opened.

FIG. 8 is a perspective view of the caddy in operation supporting pot covers and utensils.

### DETAILED DESCRIPTION

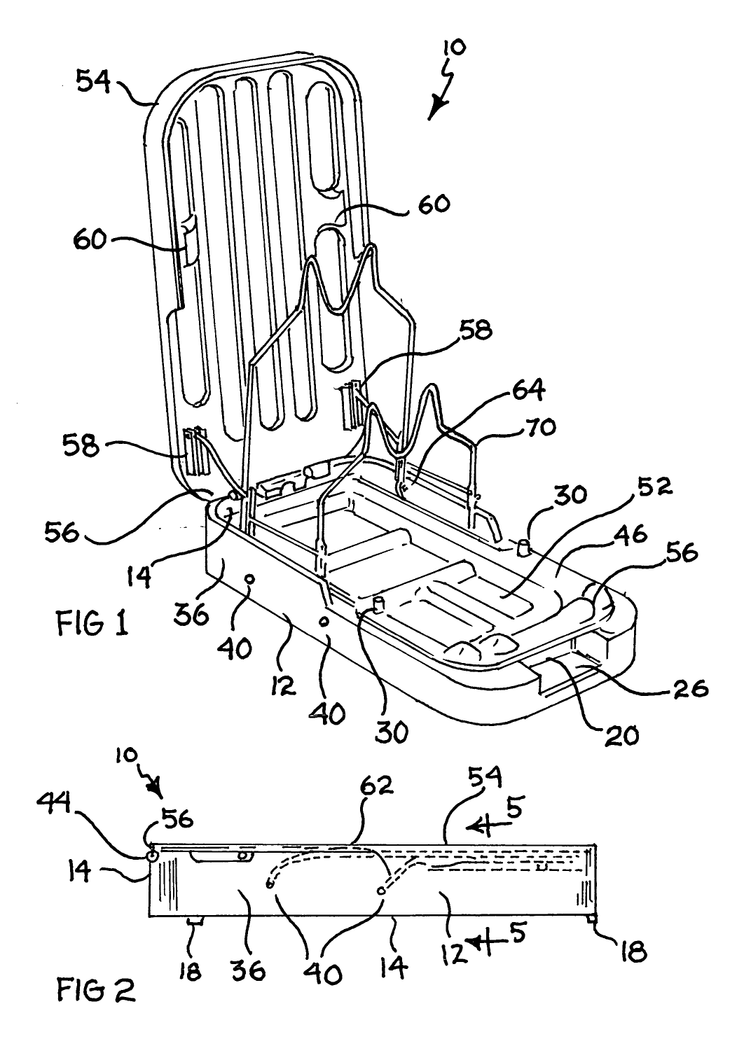

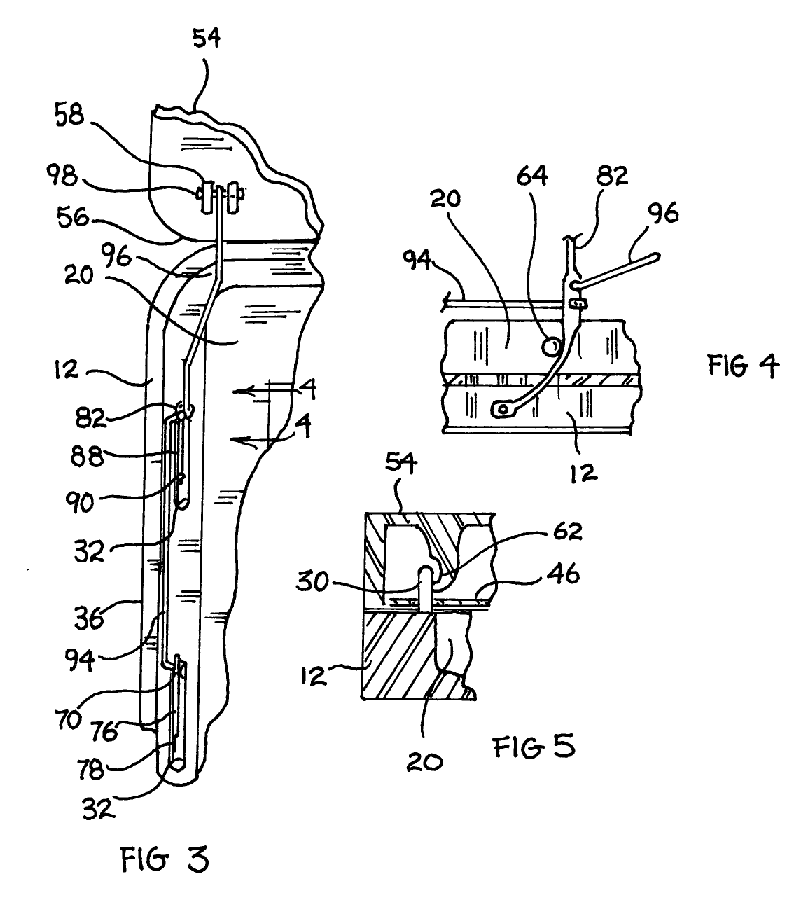

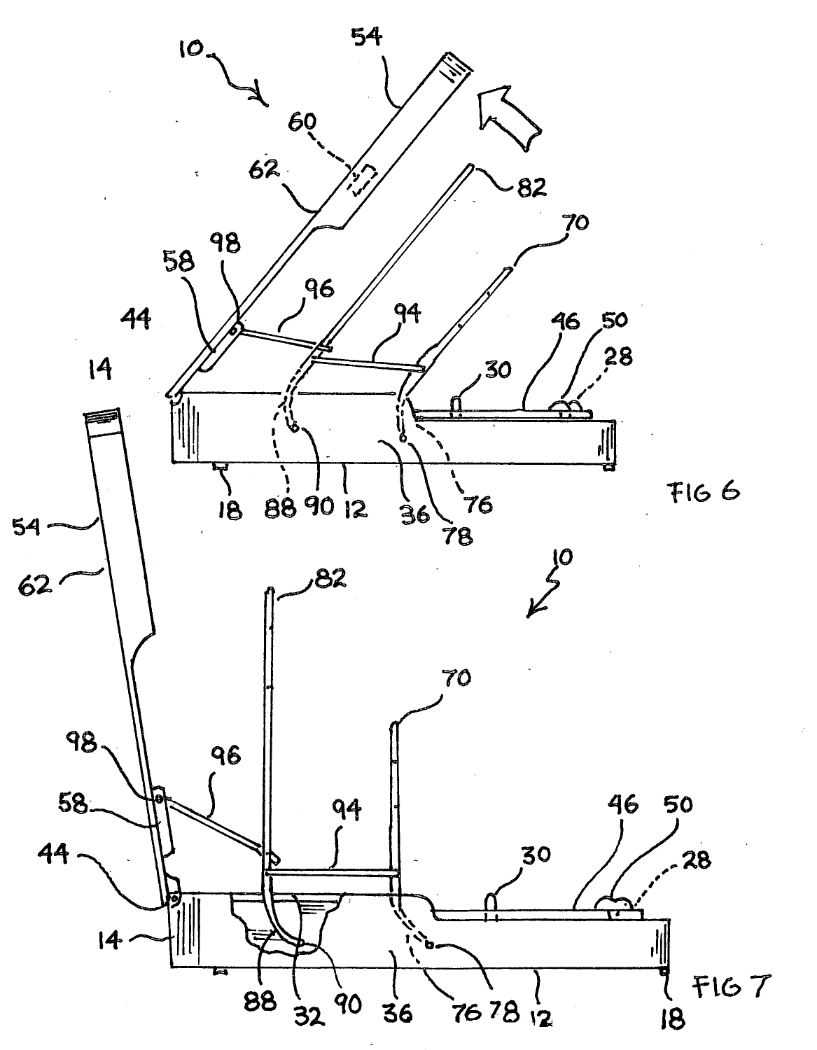

Referring to FIGS. 1 through 8, the pot cover caddy 10 may be appreciated. Generally the caddy 10 includes its hollow base 12 supporting utensil depressions 22 and insert tray 46 with additional utensil depressions 48 and pivotally upstanding first and second pot hoops 70 and 82 connected by linkages 94 and 96 to the caddy 10 cover 54 suitably connected to the base 12 by hinge 44.

More specifically, the pot cover caddy 10 has its base 12 with a back wall 14. The back wall supports rubber friction feet 18 to ensure that the caddy 10 is relatively immobile when in use.

The base 12 has an inside cavity 20 sectioned into utensil depressions 22 suitably for supporting various utensils such as spoons or spatulas 24 as shown in FIG. 8. The base has a handle opening 26 for gripping and indexing pegs 28 cover gripping pegs 30, cover hoop slots 32 and side walls 36 which will further be appreciated herein.

The back wall 14 of the base 12 supports a hinge 44 for cover 54. Within the inside cavity 20 is an insert tray 46 suitably with additional utensil depressions 48 for use within the pot cover caddy 10 or outside on the countertop or stove, The indexing peg depressions 50 index the insert tray 46 with the indexing pegs 28 within the base 12 to ensure proper location of the tray within the inside cavity 20 of the base 12. The tray also suitable has cover peg apertures 52 for further indexing and permitting exposure of the cover gripping pegs 30 mounted in the base 12.

The cover 54 has a lower end 56 which is connected to the hinge 44. Adjacent the lower end 56 are linkage ears 58. Upwardly are located detents 60 for securely indexing with the cover gripping pegs 30. The cover 54 included linkage detents pegs 64 to hold and lock the cover 54 open. A recipe surface 66 is provided which may also support a measuring unit chart or some form of or in the alternative, art work or art design.

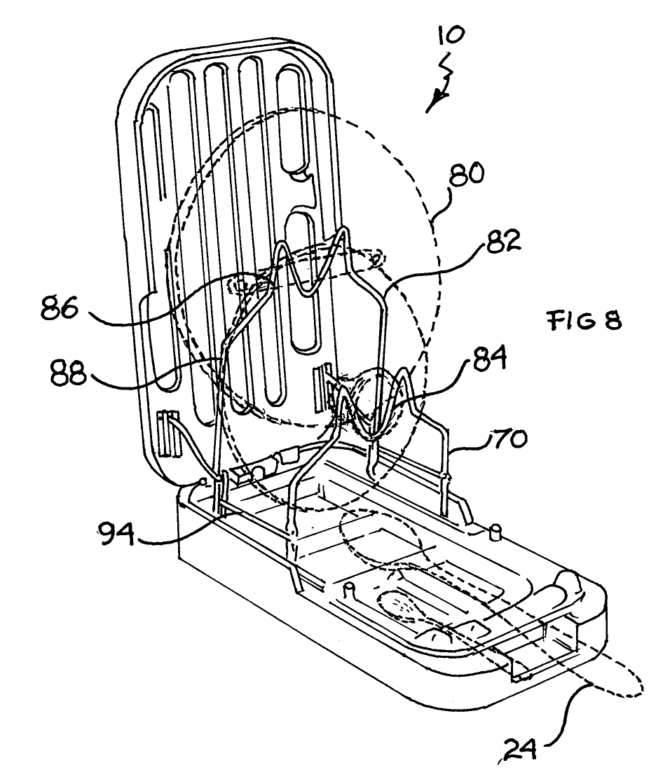

The first pot cover hoop 70 has a round handle support portion 72 and two upwardly projecting u-shaped handle support portions 74. The curve legs 76 of the hoop end in pivot mounted ends 78 which are mounted within the cover hoop slots 32 and are permitted to extend upwardly from the lower most position with no movement further backward as to support the caddy 10 in its upright position as further shown in FIG. 7.

Pot covers 80 as shown in FIG. 8 are supported by the first pot cover hoop 70 and by the second larger pot cover hoop 82 which also has a round handle support portion 84 and a u-shaped handle support portion 86 with depending curved legs 88 suitably mounted in the cover hoop slots 32 by their pivotally mounted ends 90.

Hoop linkages 94 connect the first and second hoops 70 and 82 and are further connected to the cover 54 by cover second hoop linkage 96 with its pivot pin 98 mounted in the linkage ears 58.

1. I claim this apparatus to be a portable or stationary kitchen unit which consists of a support bottom and top which house hoops to hold pot and pan covers during the cooking and storage process as well as a removable drip tray and utensil storage tray.

2. As set forth in claim 1, the apparatus further is comprised of a hinge assembly which is incorporated to the support bottom and top cover.

3. As set forth in claim 2, the apparatus further comprises of pivotally mounted hoops attached to the hinged support bottom and top cover by linkage, which upon lifting the top cover makes the hoops go into an upright position ready to accept covers and when lowering the top cover makes the hoops go back into their original lowered position.

4. As set forth in claim 3, the apparatus further comprises a recessed easy access frontal grab area in the hinged support bottom.

5. As set forth in claim 4, the apparatus further comprises of a partitioned utensil storage area in the support bottom.

6. As set forth in claim 5, the apparatus further comprises two pins in the support bottom which hold in place a removable drip tray.
